(19) United States
(12) Patent Application Publication
(10) Pub. No.: US 2005/0289554 A1
(43) Pub. Date: Dec. 29, 2005

(54) System and method for application management

(75) Inventors: Tomi Arponen, Kouvola (FI); Juha Muhonen, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/868,300

(22) Filed: Jun. 14, 2004

(51) Int. Cl. G06F 3/00

(52) U.S. Cl. 719/310

(57) ABSTRACT

Embodiments of the present invention include device, methods, and computer code products for management of applications. The device includes a server adapted to either receive or monitor information related an event. The device further includes one or more application interface modules adapted to communicate with the server. Each of the application interface modules is associated with an application and is adapted to receive information related to the event.

### BACKGROUND OF THE INVENTION

The present invention relates generally to the field of electronic devices, and particularly to systems and methods of managing applications available on electronic devices such as mobile phones.

Electronic devices, such as mobile or cellular phones, generally include a variety of applications to support various functions. Each of these applications is launched when the device is booted up to ensure the application is always available. However, many of these applications are only required occasionally. For example, an electronic mail application on a mobile phone or a personal digital assistant may only be required when a new electronic mail message is received. But to ensure availability, the application must run in the background, thereby utilizing valuable resources, such as processor and memory capacity, of the electronic device.

### SUMMARY OF THE INVENTION

One embodiment of the invention relates to an electronic device. The device includes a server adapted to either receive or monitor information related an event. The device further includes one or more application interface modules adapted to communicate with the server. Each of the application interface modules is associated with an application and is adapted to receive information related to the event.

In another embodiment, a method of managing applications in an electronic device includes notifying an application interface module of an event by an online server, the application interface module being associated with an application of the electronic device.

The following description of certain embodiments serves to explain the invention in greater detail in conjunction with the drawings.

### BRIEF DESCRIPTION OF THE DRAWINGS

FIG. 1 is a schematic illustration of an architecture of a system according to an embodiment of the invention; and

FIG. 2 is a flow chart illustrating the operation of an application management system according to an embodiment of the invention.

### DETAILED DESCRIPTION OF THE PREFERRED EMBODIMENTS

Embodiments of the present invention provide systems and methods which allow resources of an electronic device to be conserved. In this regard, an online server interfaces with an application interface module for each specified application. The online server monitors certain characteristics or parameters, some of which may signify events. The online server notifies each application interface module of the event, and the application interface module for each application can determine whether the event warrants any action relating to the corresponding application, such as launching the application or notifying a user. Thus, the corresponding application need not be launched at boot up, but rather can be launched at a later time that the application interface module determines to be appropriate.

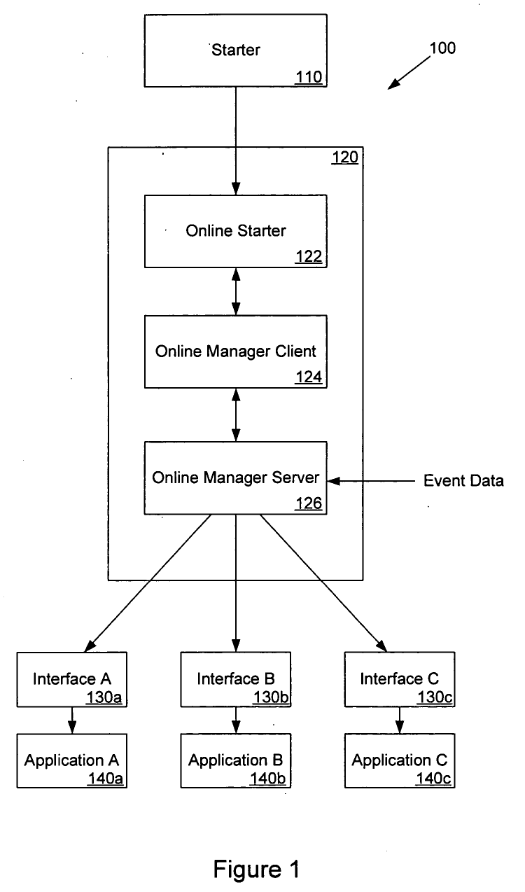

FIG. 1 illustrates an architecture of a system according to an embodiment of the invention. The system 100 may be implemented in an electronic device such as a mobile phone, personal digital assistant or the like. The system 100 includes a starter 110 which manages the boot-up operation of the electronic device. During the boot-up operation, among other operations, the starter 110 launches an online server 120 within the electronic device. The online server 120 is adapted to be available anytime the electronic device is in operation. Thus, the online server 120 remains online until the device, or the system 100, is shut down and becomes available again when the device or system 100 is re-booted. In this regard, the term “online” refers to the availability of the server and not necessarily to any specific networked environment.

The online server 120 includes an online starter 122, which is an executable adapted to be started by the system starter 110. The online starter 122 then starts the online server 120.

The online server 120 includes a client-server arrangement which includes an online manager client 124 and an online manager server 126. The online manager client 124 includes an application program interface (API) to allow external programs or modules to access the online manager server 126 to, for example, send commands to one or more applications 140a-c. The online manager server 126 is adapted to monitor or receive information relating to one or more of the applications 140a-c and to communicate that information to one or more application interface modules 130a-c. Thus, the application interface modules 130a-c are updated with current information relating to such parameters as roaming status, offline mode, low diskspace, low memory, low battery power, and electronic mail status, for example.

The event data may include any parameters which may be of use to one or more applications. For example, the data may include information indicative of the roaming status of a mobile phone. Thus, when a user travels outside of a home region, the mobile phone may, through the monitoring of the location, determine that the mobile phone is now in roaming mode. In other embodiments, the data may be indicative of the arrival of an electronic mail message.

The application interface modules 130a-c may be implemented as plug-ins. In a particular embodiment, the electronic device and the system 100 use the Symbian operating system, and the application interface modules 130a-c are plug-ins according to the ECom framework provided for within the Symbian operating system. Such plug-ins allow passing of data with specific desired properties. For additional details on Symbian and ECom, reference may be made to www.symbian.com.

The application interface modules 130a-c are launched by the online manager server 126 when the online server 120 is started by the online starter 122. In this regard, the online manager server 126 may access a list of plug-ins registered to be launched as application interface modules, for example, or identify plug-ins to be launched as application interface modules by detecting a predetermined parameter.

Each application interface module 130a-c corresponds to a specific application within the set of applications 140a-c and is adapted to communicate with the online server 120 to receive events or information related to its corresponding application. Every application for which online availability is required should have a corresponding application interface module 130a-c.

During installation, the application interface module 130a-c may be adapted or configured to communicate with the online server 120 on behalf of the corresponding application. For example, an application interface module 130 corresponding to an electronic mail application may be configured to determine actions to be taken when event data is received. Thus, if event data indicates that a new electronic mail message has arrived, the application interface module corresponding to the electronic mail application may cause the application to be launched or a notification to be sent to a user. If the notification is sent to the user, for example, the user may determine whether or not to launch the application.

In one embodiment, the configuration of the application interface modules 130 may be standardized. Thus, a standard plug-in may be provided. The configuration o fthe standard plug-in can be customized for a variety of corresponding applications.

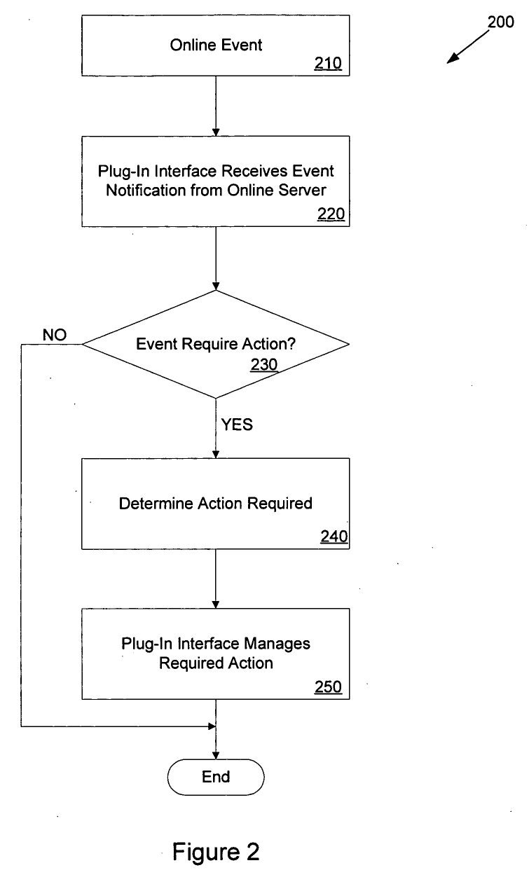

FIG. 2 is a flow chart illustrating the operation of an application management system according to an embodiment of the invention. The process 200 begins when an online event is detected or received (block 210). The event may be based on event data received by the online manager client 124 of FIG. 1. The event data may be processed by the online server 120 prior to passing to the application interface modules. For example, with regard to roaming, the event data received by the online server 120 may be raw location data which is processed to determine a change in roaming status, and the change in roaming status is then forwarded to each application interface module 130a-c (block 220). In other embodiments, the raw data may be forwarded to each application interface module 130a-c, which may then process the data to determine whether an event has occurred.

Upon receipt, detection or determination of an event, an application interface module may determine whether the event requires any action (block 230). For example, if the application interface module corresponds to an electronic mail application, an event indicating a change in roaming status may not require any action. However, the same event may require action if the application interface module corresponds to a system management application. The determination may be made by the application interface module based on configuration of the application interface module at installation of the module and/or the corresponding application.

If the application interface module determines that the event requires action, it may determine the specific action to be taken (block 240). The determination of the specific action may also be made according to the configuration of the application interface module at installation. Thus, an application interface module corresponding to an electronic mail application may determine that the receipt of a standard electronic mail requires notifying a user of the event, while the receipt of an electronic mail marked as “URGENT” requires that the application be launched and the message displayed to the user.

Once the proper action to be taken has been determined, the application interface module manages the required action (block 250). The application interface module may then cause the required actions to be taken. For example, if the action determined to be required by the application interface module is to launch the application, the application interface module can start the corresponding one of the applications 140a-c. If the action required is to notify a user, the application interface module may cause an alert to be displayed or sounded to the user, for example.

Thus, the applications corresponding to each of the application interface modules 130a-c is not required to be launched at boot up and do not consume valuable resources of the device. Further, the applications 140a-c are not each required to monitor various parameters for appropriate events. That aspect can be centrally managed by the online server 120.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. An electronic device, comprising:
a server adapted to either receive or monitor information related to an event; and
one or more application interface modules adapted to communicate with said server, each of said application interface modules being associated with an application and adapted to receive information related to said event.

2. The device of claim 1, wherein the application interface module is adapted to determine any actions required based on said information.

3. The device of claim 1, wherein the application interface module is adapted to cause an associated application to be launched.

4. The device of claim 1, wherein the application interface module is adapted to cause a notification of a user.

5. The device of claim 1, wherein the application interface module is a plug-in module.

6. The device of claim 1, wherein the application interface module is a standardized plug-in module adapted to be customized for one or more applications.

7. The device of claim 1, wherein the information includes a change in roaming status.

8. The device of claim 1, wherein the information includes a receipt of data.

9. The device of claim 8, wherein the data includes an electronic mail message.

10. The device of claim 1, wherein the application is an electronic mail application.

11. The device of claim 1, wherein the application is a system management application.

12. A method of managing applications in an electronic device, comprising:
notifying an application interface module of an event by an online server, the application interface module being associated with an application of the electronic device.

13. The method of claim 12, further comprising:
determining whether the event requires an action related to the application.

14. The method of claim 12, further comprising causing said application to be launched.

15. The method of claim 12, further comprising causing a notification of a user.

16. The method of claim 12, wherein the application interface module is a plug-in module.

17. The method of claim 12, wherein the application interface module is a standardized plug-in module adapted to be customized for one or more applications.

18. The method of claim 12, wherein the event includes a change in roaming status.

19. The method of claim 12, wherein the event includes a receipt of data.

20. The method of claim 19, wherein the data includes an electronic mail message.

21. The method of claim 12, wherein the application is an electronic mail application.

22. The method of claim 12, wherein the application is a system management application.

23. A program product, comprising machine readable program code for causing a machine to perform the following method steps:
notifying an application interface module of an event by an online server, the application interface module being associated with an application of the electronic device.

24. The program product of claim 23, further comprising machine readable program code for causing a machine to perform the following method step: determining whether the event requires an action related to the application.

25. The program product of claim 23, further comprising machine readable program code for causing a machine to perform the following method step: causing said application to be launched.

26. The program product of claim 23, further comprising machine readable program code for causing a machine to perform the following method step: causing a notification of a user.

27. The program product of claim 23, wherein the application interface module is a plug-in module.

28. The program product of claim 23, wherein the application interface module is a standardized plug-in module adapted to be customized for one or more applications.

29. The program product of claim 23, wherein the event includes a change in roaming status.

30. The program product of claim 23, wherein the event includes a receipt of data.

31. The program product of claim 30, wherein the data includes an electronic mail message.

32. The program product of claim 23, wherein the application is an electronic mail application.

33. The program product of claim 23, wherein the application is a system management application.
